(19) United States
(12) Patent Application Publication
(10) Pub. No.: US 2018/0009041 A1
(43) Pub. Date: Jan. 11, 2018

(54) EASILY DETACHABLE COLLET

(71) Applicant: Chin-Chiu Chen, Taichung City (TW)

(72) Inventor: Chin-Chiu Chen, Taichung City (TW)

(21) Appl. No.: 15/202,900

(22) Filed: Jul. 6, 2016

(51) Int. Cl. B23B 31/20

(52) U.S. Cl. CPC B23B 31/20; B23B 2231/2008; B23B 2231/2091

(57) ABSTRACT

An easily detachable collet has two opposite ends, a conjoint portion, a fastening cap abutting portion, an annular groove, a through hole, and multiple slits. The conjoint portion is arranged at one of the two opposite ends of the collet. The fastening cap abutting portion is annularly formed at the other end of the collet. The fastening cap abutting portion has a convex outline in cross section. The annular groove is formed between the conjoint portion and the fastening cap abutting portion. The through hole is axially defined through the collet. The multiple slits are radially defined in the collet and communicate with the through hole. Each slit extends to one of the two opposite ends of the collet. The fastening cap abutting portion with a convex outline in cross section enables the collet to be smoothly and easily detached from a fastening cap.

### BACKGROUND OF THE INVENTION

### 1. Field of the Invention

The present invention relates to a machine tool, and more particularly to a collet that can easily be separated from a cutter holder.

### 2. Description of Related Art

A cutter holder is assembled on a spindle of a machine for fastening cutters of different specifications.

With reference to FIGS. 5 and 6, a conventional cutter holder comprises a body 60, a collet 70, a cutter 80, and a fastening cap 90.

The body 60 has two opposite ends and an inner socket 61. The inner socket 61 is a tapered hole which extends from one of the two ends of the body 60 to the other end of the body 60.

The collet 70 has two opposite ends, a conjoint portion 71, a fastening cap abutting portion 72, and an annular groove 73. The conjoint portion 71 is conical, corresponds to the inner socket 61 in sectional shape, and is disposed at one of the two ends of the collet 70. The conjoint portion 71 is mounted in the inner socket 61 of the body 60.

The fastening cap abutting portion 72 is disposed at the other end of the collet 70. The fastening cap abutting portion 72 has a first inclined face 721 and a second inclined face 722. The annular groove 73 is disposed between the conjoint portion 71 and the fastening cap abutting portion 72. The second inclined face 722 is formed at a side of the annular groove 73.

The cutter 80 is inserted into the collet 70. The fastening cap 90 is screwed with the body 60. The fastening cap 90 has two opposite ends and an engaging portion 91. The engaging portion 91 is arranged at one of the two ends of the fastening cap 90, is held in the annular groove 73 of the collet 70, and is limited by the fastening cap abutting portion 72. The engaging portion 91 is annular and has a loop of chamfer 911.

The engaging portion 91 of the fastening cap 90 is limited by the fastening cap abutting portion 72 of the collet 70 to prevent the fastening cap 90 from being separated from the collet 70 during machining. However, when the collet 70 and the fastening cap 90 are demounted from each other, the chamfer 911 of the engaging portion 90 is abutted by the second inclined face 722 of the fastening cap abutting portion 72. Thereby, the collet 70 and the fastening cap 90 are hard to be separated from each other.

To overcome the shortcomings of the collet of the conventional cutter holder, the present invention provides an easily detachable collet to mitigate or obviate the aforementioned problems.

### SUMMARY OF THE INVENTION

The main objective of the present invention is to provide an easily detachable collet that can be easily separated from a fastening cap and save a lot of effort for demounting the collet.

The easily detachable collet comprises has two opposite ends, a conjoint portion, a fastening cap abutting portion, an annular groove, a through hole, and multiple slits. The conjoint portion is arranged at one of the two opposite ends of the collet. The fastening cap abutting portion is annularly formed at the other end of the collet. The fastening cap abutting portion has a convex outline in cross section. The annular groove is formed between the conjoint portion and the fastening cap abutting portion. The through hole is axially defined through the collet. The multiple slits are radially defined in the collet and communicate with the through hole. Each slit extends to one of the two opposite ends of the collet. The fastening cap abutting portion with a convex outline in cross section enables the collet to be smoothly and easily detached from a fastening cap.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a cutter holder with a collet in accordance with the present invention;

FIG. 2 is an enlarged exploded perspective view of the cutter holder with the collet in FIG. 1;

FIG. 3 is an enlarged side view in partial section of the cutter holder with the collet in FIG. 1;

FIG. 4 is a perspective view of the collet in FIG. 2;

FIG. 5 is an exploded perspective view of a conventional cutter holder; and

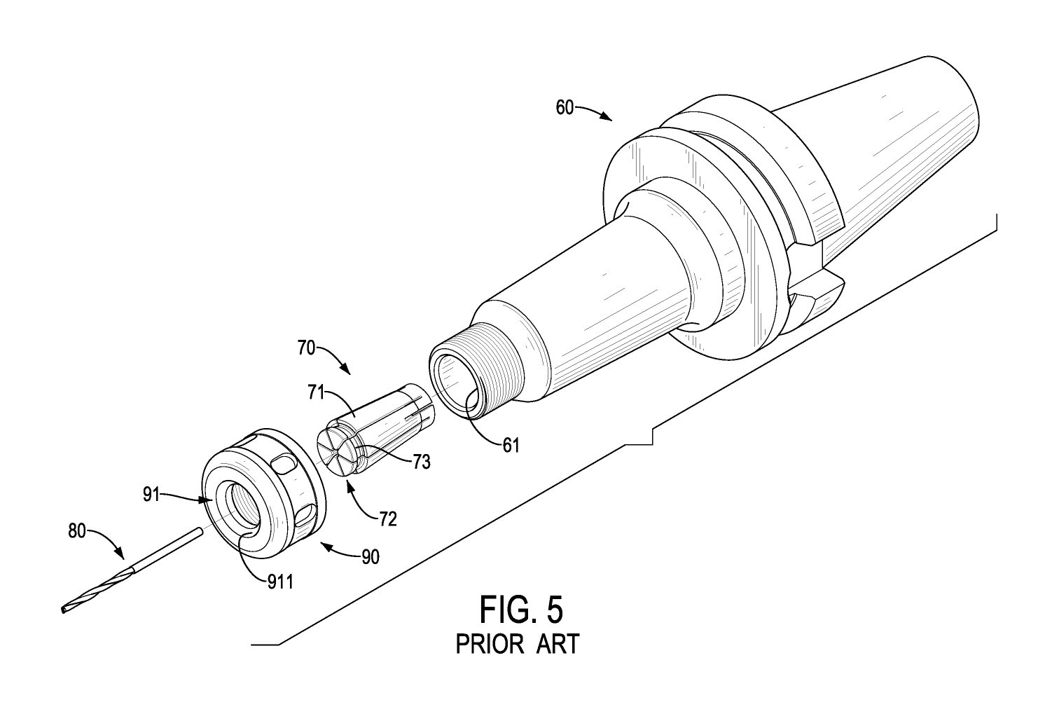

FIG. 6 is an enlarged side view in partial section of the conventional cutter holder in FIG. 5.

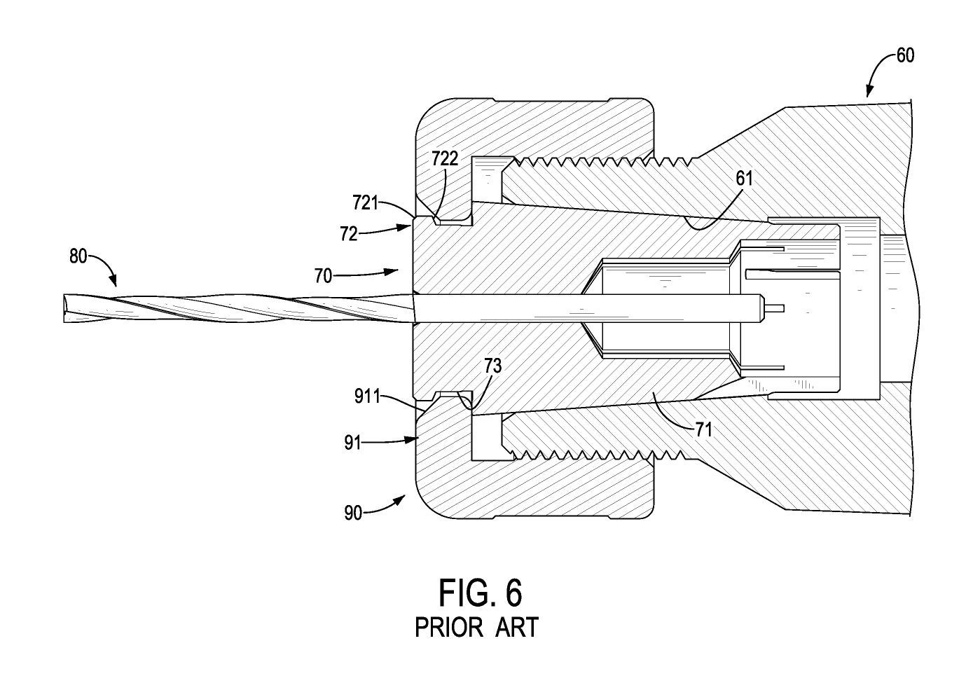

### DETAILED DESCRIPTION OF PREFERRED EMBODIMENT

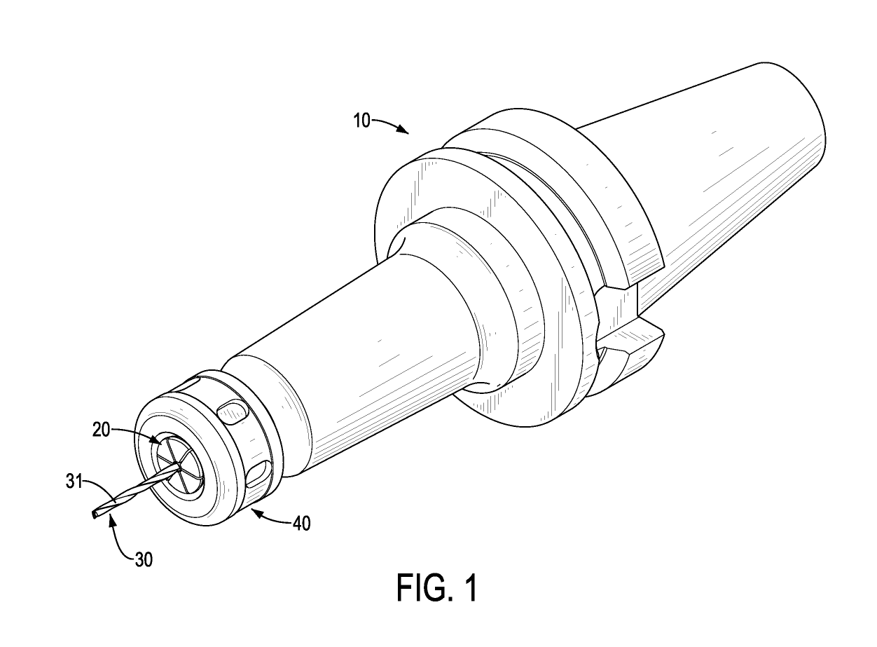

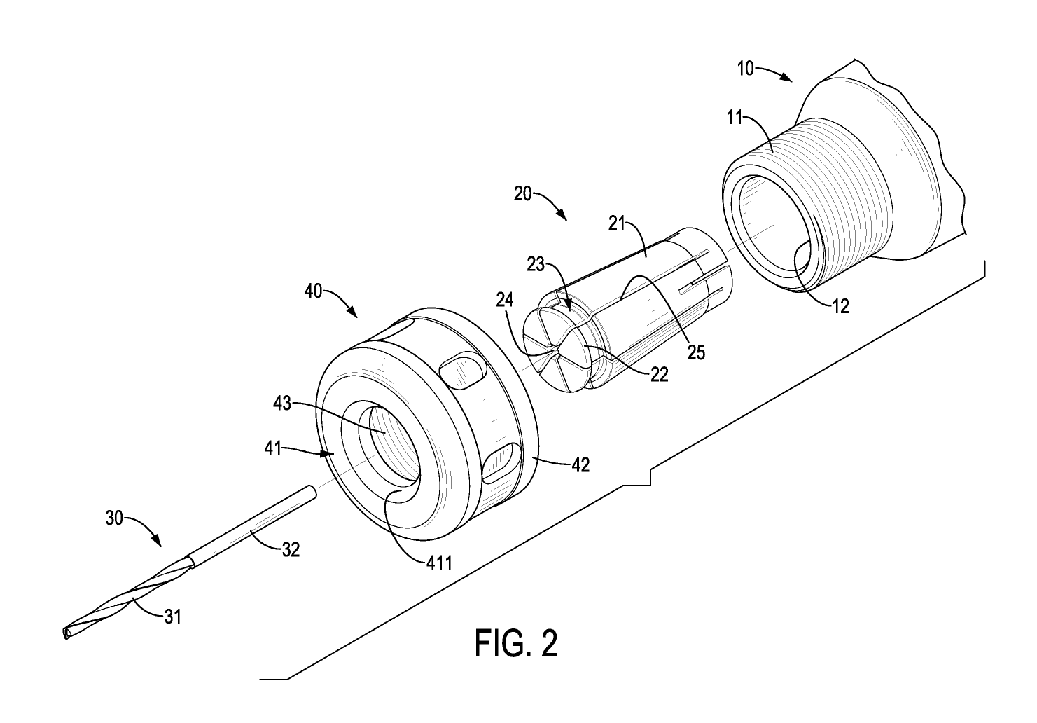

With reference to FIGS. 1 and 2, a cutter holder having an easily detachable collet in accordance with the present invention comprises a body 10, a collet 20, a cutter 30, and a fastening cap 40. The collet 20 is assembled on the body 10. The cutter 30 is inserted in the collet 20. The fastening cap 40 is assembled on the body 10 and surrounds the cutter 30.

With reference to FIGS. 1 and 2, the body 10 has a surface, a first end, a second end, an external thread 11, and an inner socket 12. The first end has an end face. The second end is opposite the first end of the body 10. The external thread 11 is arranged at the first end of the body 10 and is formed on the surface of the body 10. The inner socket 12 is arranged at the first end of the body 10. The inner socket 12 is a tapered hole and extends from the end face of the first end of the body 10 to the second end of the body 10.

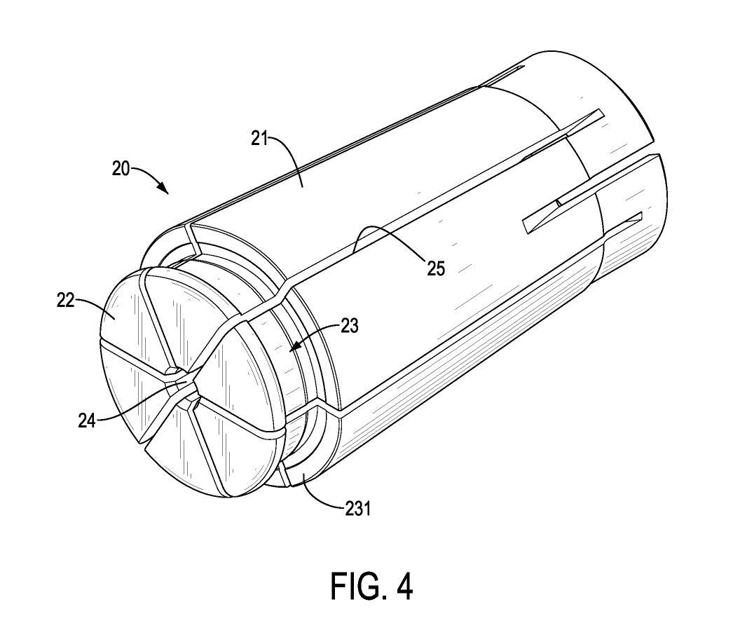

With reference to FIGS. 2, 3, and 4, the collet 20 has two opposite ends, a conjoint portion 21, a fastening cap abutting portion 22, an annular groove 23, a through hole 24 and multiple slits 25. The conjoint portion 21 is mounted in the inner socket 12, is arranged at one of the opposite ends of the collet 20, is conical, and corresponds to the inner socket 12 in sectional shape. The fastening cap abutting portion 22 is annularly formed at the other end of the collet 20. The fastening cap abutting portion 22 has a convex outline in cross section. The annular groove 23 is formed between the conjoint portion 21 and the fastening cap abutting portion 22. The annular groove 23 has a bottom face and a lateral face 231. The lateral face 231 of the annular groove 23 is perpendicular to the bottom face of the annular groove 23 and is adjacent to the conjoint portion 21. The through hole 24 is axially defined through the collet 20 and has an inner diameter. The multiple slits 25 are radially defined in the collet 20 and communicate with the through hole 24. Each slit 25 extends to one of the two opposite ends of the collet 20.

With reference to FIGS. 1, 2, and 3, the cutter 30 has two opposite ends, a cutting portion 31, and a collet assembling portion 32. The cutting portion 31 is arranged at one of the two opposite ends of the cutter 30. The collet assembling portion 32 is arranged at the other end of the cutter 30 and has an outer diameter. The outer diameter of the collet assembling portion 32 is substantially equal to the inner diameter of the through hole 24 of the collet 20

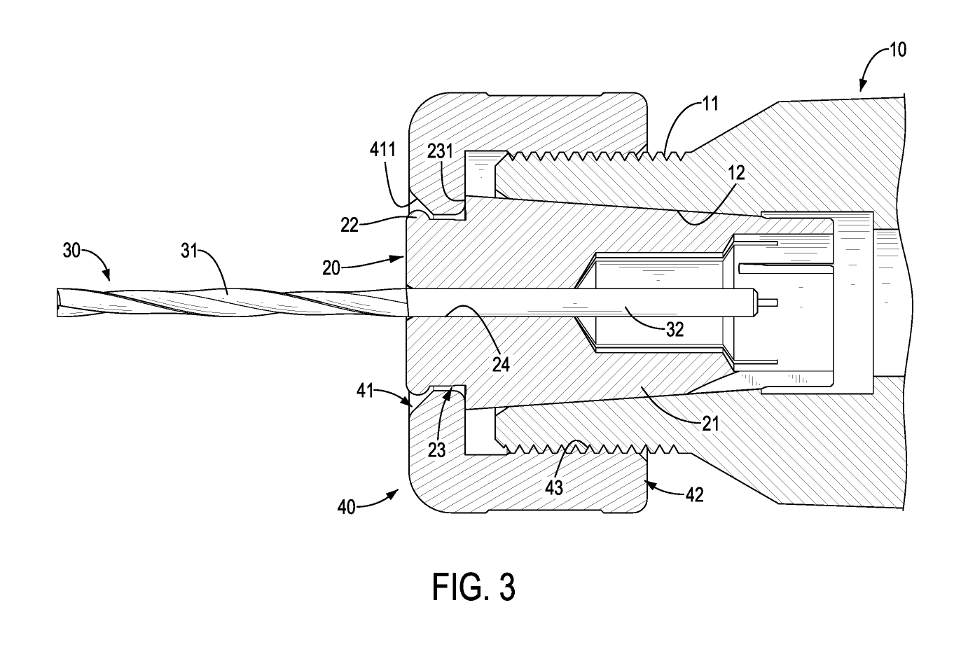

With reference to FIGS. 2 and 3, the fastening cap 40 is assembled on the body 10 and has a first end, a second end, an engaging portion 41, a surrounding wall 42, and an internal thread 43. The first end and the second end of the fastening cap 40 are opposite each other. The engaging portion 41 is arranged at the first end of the fastening cap 40, is held in the annular groove 23 of the collet 20, and is limited by the fastening cap abutting portion 22. The engaging portion 41 is annular and has a rim and a loop of chamfer 411. The chamfer 411 faces a direction that is opposite the second end of the fastening cap 40. The surrounding wall 42 is connected to the rim of the engaging portion 41 and has an inner surface. The internal thread 43 is formed on the inner surface of the surrounding wall 42. The internal thread 43 of the fastening cap 40 is screwed with the external thread 11 of the body 10. The engaging portion 41 abuts against the lateral face 231 of the groove 23 of the collet 20.

To detach the collet 20 from the fastening cap 40, the fastening cap 40 is detached from the body 10 first, and the cutter 30 is detached from the collet 20. The collet 20 and the fastening cap 40 are respectively pulled toward two opposite directions when separating the collet 20 and the fastening cap 40. A loop of contact area is formed between the fastening cap abutting portion 22 of the collet 20 and the engaging portion 41 of the fastening cap 40. The fastening cap abutting portion 22 with a convex outline in cross section smoothly slides along the chamfer 411 of the engaging portion 41. Then the slits 25 of the collet 20 enable the collet 20 to contract, thereby the collet 20 can be easily detached from the fastening cap 40. The fastening cap abutting portion 22 with a convex outline in cross section can help the collet 20 and the fastening cap 40 be easily detached from each other and saves a lot of effort for separating the collet 20 and the fastening cap 40.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A collet adapted for being assembled on a cutter holder, the collet comprising:
two opposite ends;
a conjoint portion arranged at one of the two opposite ends of the collet;
a fastening cap abutting portion annularly formed at the other end of the collet and having
a convex outline in cross section;
an annular groove formed between the conjoint portion and the fastening cap abutting portion;
a through hole axially defined through the collet; and
multiple slits radially defined in the collet, communicating with the through hole, and each slit extending to one of the two opposite ends of the collet.
